(19) United States
(12) Patent Application Publication
(10) Pub. No.: US 2015/0003991 A1
(43) Pub. Date: Jan. 1, 2015

(54) MODULAR EXTENSIONS FOR WIND TURBINE ROTOR BLADES

(71) Applicant: General Electric Company, Schenectady, NY (US)

(72) Inventors: Bharat Sampathkumaran Bagepalli, Niskayuna, NY (US); Bradley Graham Moore, Greenville, SC (US); Mohamad Babar Sultan, Simpsonville, SC (US); Jessica Elizabeth Cohn, East Greenbush, NY (US); Jessica Leigh Kadlec, Greenville, SC (US); William Arthur Flodder, Greenville, SC (US)

(73) Assignee: General Electric Company, Schenectady, NY (US)

(21) Appl. No.: 13/930,518

(22) Filed: Jun. 28, 2013

(51) Int. Cl. F03D 1/06; F03D 1/00

(52) U.S. Cl. CPC F03D 1/0675; F03D 1/003; F03D 1/001
USPC 416/233; 29/889.1

(57) ABSTRACT

Rotor blades include an inner portion and a modular extension attached to the inner portion that form a new span length for the rotor blade. The modular extension includes one or more spanwise support elements connecting to the inner portion and extending in a spanwise direction, a plurality of cross-sectional ribs disposed along a length of the one or more spanwise support elements, and, a modular extension shell surrounding the modular extension supported by the plurality of cross-sectional ribs.

### BACKGROUND OF THE INVENTION

The subject matter disclosed herein relates to wind turbine rotor blades and, more specifically, to modular extensions for modified wind turbine rotor blades.

Wind power is considered one of the cleanest, most environmentally friendly energy sources presently available, and wind turbines have gained increased attention in this regard. A modern wind turbine typically includes a tower, generator, gearbox, nacelle, and one or more rotor blades. The rotor blades capture kinetic energy of wind using known foil principles. The rotor blades transmit the kinetic energy in the form of rotational energy so as to turn a shaft coupling the rotor blades to a gearbox, or if a gearbox is not used, directly to the generator. The generator then converts the mechanical energy to electrical energy that may be deployed to a utility grid.

The particular size of wind turbine rotor blades is a significant factor contributing to the overall efficiency of the wind turbine. Specifically, increases in the length or span of a rotor blade may generally lead to an overall increase in the energy production of a wind turbine. Accordingly, efforts to increase the size of rotor blades aid in the continuing growth of wind turbine technology and the adoption of wind energy as an alternative energy source. However, modifying designs and manufacturing processes for new rotor blades may require significant resources.

Accordingly, alternative rotor blades would be welcome in the art.

### BRIEF DESCRIPTION OF THE INVENTION

In one embodiment, a rotor blade for a wind turbine is provided. The rotor blade includes an inner portion and a modular extension attached to the inner portion and forming a new span length for the rotor blade. The modular extension includes one or more spanwise support elements connecting to the inner portion and extending in a spanwise direction, a plurality of cross-sectional ribs disposed along a length of the one or more spanwise support elements, and, a modular extension shell surrounding the modular extension supported by the plurality of cross-sectional ribs.

In another embodiment, a method for modifying a rotor blade is provided. The method includes providing an inner portion, connecting one or more spanwise support elements to the inner portion such that the one or more spanwise support elements extend in a spanwise direction, connecting a plurality of cross-sectional ribs to the one or more spanwise support elements, the plurality of cross-sectional ribs disposed along a length of the one or more spanwise support elements, and, connecting a modular extension shell that surrounds and is supported by the plurality of cross-sectional ribs.

These and additional features provided by the embodiments discussed herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the inventions defined by the claims. The following detailed description of the illustrative embodiments can be understood when read in conjunction with the following drawings, where like structure is indicated with like reference numerals and in which:

FIG. 1 is a perspective view of a wind turbine according to one or more embodiments shown or described herein;

FIG. 2 is a perspective view of an original rotor blade according to one or more embodiments shown or described herein;

FIG. 3 is a schematic view of a partial rotor blade including a plurality of spanwise support elements according to one or more embodiments shown or described herein;

FIG. 4 is another schematic view of a partial rotor blade including a plurality of spanwise support elements according to one or more embodiments shown or described herein;

FIG. 5 is a schematic view of an alternative partial rotor blade including a single spanwise support element according to one or more embodiments shown or described herein;

FIG. 6 is a schematic view of a partial rotor blade including a plurality of cross-sectional ribs according to one or more embodiments shown or described herein;

FIG. 7 is a perspective view of spanwise support elements connected to a cross-sectional rib according to one or more embodiments shown or described herein;

FIG. 8 is a schematic view of a rotor blade including a plurality of spanwise support elements according to one or more embodiments shown or described herein;

FIG. 9 is a schematic view of a rotor blade including a single spanwise support element according to one or more embodiments shown or described herein;

FIG. 10 is a schematic view of a modular extension shell according to one or more embodiments shown or described herein; and,

FIG. 11 is an exemplary method for manufacturing a rotor blade according to one or more embodiments shown or described herein.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

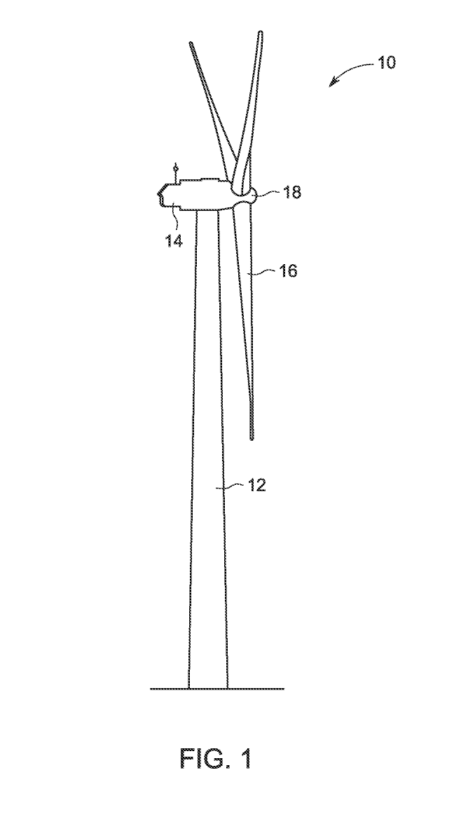

Referring to FIG. 1, a wind turbine 10 is illustrated. The wind turbine 10 includes a tower 12 with a nacelle 14 mounted thereon. A plurality of rotor blades 16 are mounted to a rotor hub 18, which is, in turn, connected to a main flange that turns a main rotor shaft. The wind turbine power generation and control components are housed within the nacelle 14. It should be appreciated that the view of FIG. 1 is provided for illustrative purposes only to place the present subject matter in an exemplary field of use. Thus, one of ordinary skill in the art should readily appreciate that the present subject matter need not be limited to any particular type of wind turbine configuration.

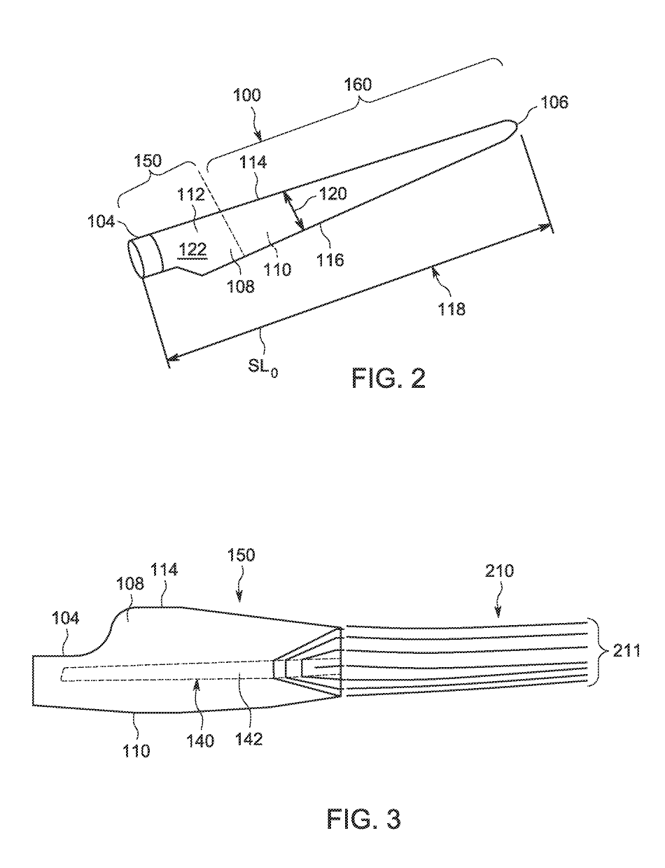

Referring to FIG. 2, in general, the disclosed original rotor blade 100 may include a blade root 104 configured for mounting the rotor blade 100 to the hub 18 of the wind turbine 10 (FIG. 1) and a blade tip 106 disposed opposite the blade root 104. A shell 108 of the rotor blade 100 may generally be configured to extend between the blade root 104 and the blade tip 106 and may serve as the outer casing/covering having an outer surface 122 of the rotor blade 100. In several embodiments, the shell 108 may define a substantially aerodynamic profile, such as by defining a symmetrical or cambered airfoil-shaped cross-section. As such, the shell 108 may define a pressure side 110 and a suction side 112 extending between a leading edge 114 and a trailing edge 116. Further, the rotor blade 100 may have a span 118 defining the total length between the blade root 104 and the blade tip 106 and a chord 120 defining the total length between the leading edge 114 and the trialing edge 116. As is generally understood, the chord 120 may vary in length with respect to the span 118 as the rotor blade 100 extends from the blade root 104 to the blade tip 106.

Referring to FIGS. 2 and 3, the original rotor blade 100 can be separated into an inner portion 150 and an outer portion 160. The inner portion 150 of the original rotor blade 100 comprises at least the blade root 104 and potentially a further portion of the span 118. Likewise, the outer portion 160 of the original rotor blade comprises the remainder of the span 118 not included in the inner portion 150 and the blade tip 106.

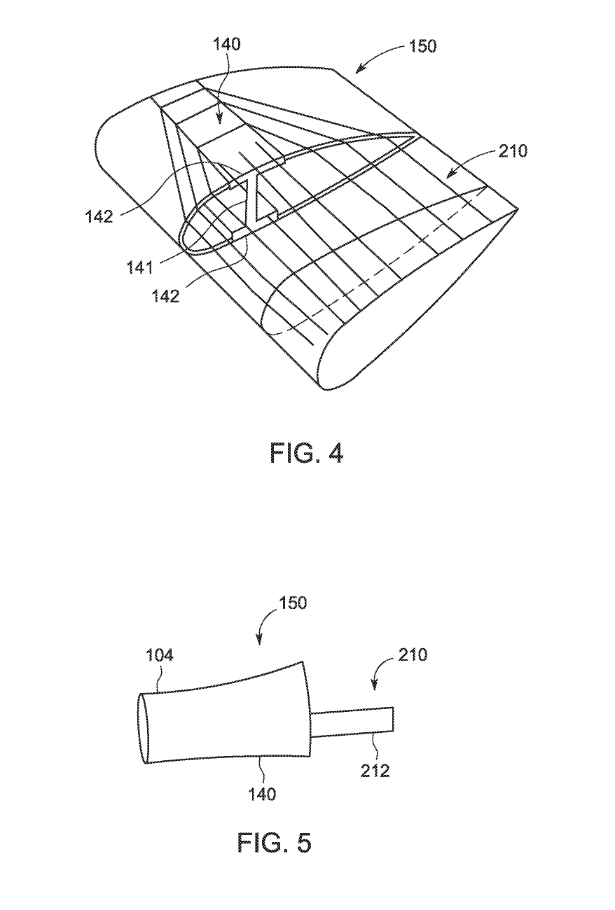

The inner blade portion 160 can further comprise any and all internal structural elements present in the original rotor blade 100. For example, the inner blade portion 160 can comprise the internal support structure 140 utilized to provide structural support to the original rotor blade 100 along its span 118. In some embodiments, such as that illustrated in FIG. 4, the internal support structure 140 for the original rotor blade 100 may comprise a shear web 141 connected to one or more spar caps 142. In some embodiments, the internal support structure 140 may comprise additional or alternative support structures such as trusses, lattices or the like.

The inner portion 150 may be separated from the outer portion 160 through any suitable system. For example, the inner portion 150 may be separated using saws, blades, torches, lasers or any other suitable device. In some embodiments, the inner portion 150 may have been manufactured without an outer portion 160 such that separation of the two portions is not required. Moreover, the inner portion 150 may comprise any length or percentage of the original rotor blade 100 suitable for connection with a subsequent modular extension 201. For example, in some embodiments the inner portion 150 may comprise only the first 5-10 meters of the original rotor blade 100. In other embodiments, the inner portion 150 may comprise the first 25%, 50% or more of the original rotor blade 100. In some embodiments, such as that illustrated in FIG. 5, the inner portion 150 may comprise a standardized root stub that facilitates future connections with one or more spanwise support elements 210 as will become appreciated herein. The standardized root stub may extend past the remainder of the inner portion 150 (such that it will at least partially extends into the modular extension 201 as will become appreciated herein), be flush with the edge of the inner portion 150, or even be recessed within the inner portion 150.

Referring now to FIGS. 3-9, a rotor blade 200 as disclosed herein comprises the inner portion 150 (either from an original rotor blade 100 or as part of a new make part) in addition to a modular extension 201. The modular extension 201 generally comprises one or more spanwise support elements 210 that connect to the inner portion 150 and extend in a spanwise direction towards the new blade tip 206, a plurality of cross-sectional ribs 220 disposed along a length L of the one or more spanwise support elements 210, and a modular extension shell 230 surrounding the modular extension 201 (and the plurality of cross-sectional ribs 220) supported by the plurality of cross-sectional ribs 220.

As will become appreciated herein, the modular extension 201 can be utilized to extend or shorten the original rotor blade 100 or complete a new make rotor blade by using a plurality of modular components. In some embodiments, the modular components may be customized (e.g., cut) in the field to suit individual blade requirements. In some embodiments, the modular components may be provided in a variety of preselected sizes. The modular extension 201 can thereby allow for the modification of an original rotor blade 100 or new make rotor blade either in the field (e.g., at or near the site of the wind turbine 10), in a maintenance facility and/or at the place of original manufacturing.

As best illustrated in FIGS. 3-5, the one or more spanwise support elements 210 are elongated elements (e.g., stringers) that can connect to the inner portion 150 and extend in a spanwise direction towards the new blade tip 206. It should be appreciated that the “spanwise direction” refers to the direction extending parallel to the span 118. The spanwise support elements 210 can thereby individually or collectively serve as an internal support structure for the modular extension 201 similar to (but not necessarily the same as) the internal support structure 140 for the original rotor blade 100. The one or more spanwise support elements 210 may be provided in any number, configuration and material that suitably support the new span length SL_{N} of the rotor blade 200.

The one or more spanwise support elements 210 can comprise any material or materials suitable for supporting the modular extension 201. For example, the one or more spanwise support elements 210 may comprise any suitable composite material, fiber material, laminate material, metal, alloy or the like. When there are multiple spanwise support elements 210, each of these spanwise support elements 210 can comprise the same material or different materials. Additionally, the one or more spanwise support elements 210 can comprise the same material or a different material than the internal support structure 140.

In some embodiments, such as that illustrated in FIGS. 3 and 4, the one or more spanwise support elements 210 may comprise a plurality of spanwise support elements 211. The plurality of spanwise support elements 211 can replace the internal support structure 140 that was or would have been present in the original rotor blade 100 for the modular extension 201 of the rotor blade 200. In some embodiments, the plurality of spanwise support elements 211 may be distributed around at least a portion of the outer circumference of the modular extension 201 such as proximate the modular extension shell 230 as should become appreciated herein. In other embodiments, the plurality of spanwise supports 211 may be distributed additionally or alternatively more towards the interior of the modular extension 201.

The plurality of spanwise support elements 211 can connect to the inner portion 150 through a variety of suitable connections. For example, in some embodiments, such as when the inner portion 150 comprises a spar cap 142, the plurality of spanwise support elements 211 may be connected to the spar cap 142 such that their loads are distributed there between. The plurality of spanwise support elements may taper toward the spar cap 142 once in the inner portion 150 (such as illustrated in FIGS. 3-4 and 6) or may connect through any other suitable configuration. In even some embodiments, the portion of the plurality of spanwise support elements 211 disposed in the inner portion 150 may be secured to the inner portion 150 (e.g., integrated or secured to the shell 108) prior to attaching the portion of the plurality of spanwise support elements 211 in the rotor blade 200. Likewise, in other embodiments when the inner portion 150 comprises any other type of internal support structure 140, the plurality of spanwise support elements 211 can connect to that specific internal support structure 140 at one or more locations. Moreover, the plurality of spanwise support elements 21 may be secured at the connection point(s) via any suitable adhesive, bolts, screws, pins, laminates or the like.

In some embodiments, the plurality of spanwise support elements 211 may all extend substantially parallel to one another in the spanwise direction (e.g., the same general direction as the internal support structure 140 of the inner portion 150). In other embodiments, the plurality of support elements 211 may extend as a truss-like or lattice-like network such that individual support elements 211 extend in different directions but combine to form a supporting structure for the modular extension 201.

The plurality of spanwise support elements 211 may further comprise any cross-sectional configuration and length suitable to support the modular extension 201 as should be appreciated herein. For example, in some embodiments, the plurality of spanwise support elements 211 may comprise a “C” shaped cross-section (as illustrated in FIG. 7), an “I” shaped cross-section (similar to a commercially available I-beam), a cylindrical cross-section, linear cross-section, or any other suitable design.

Moreover, in some embodiments, each of the plurality of spanwise support elements 211 may have the same initial length L. In such embodiments, the final lengths of each of the spanwise support element 211 can be customized (via cutting, grinding, sawing, or the like) for that specific rotor blade 200 at that specific location. In some embodiments, the plurality of spanwise support elements 211 may be selected a group of spanwise support elements 211 having a set amount predetermined lengths. For example, the plurality of spanwise support elements 211 may be selected from a certain predetermined length options based on the desired extension length for that particular rotor blade 200.

In some embodiments, such as that illustrated in FIGS. 5 and 9, the one or more spanwise support elements 210 may comprise a single spanwise support element 212. The single spanwise support element 212 can replace the internal support structure 140 that was or would have been present in the original rotor blade 100 for the modular extension 201 of the rotor blade 200. In some embodiments, the single spanwise support 212 may be disposed towards the interior of the modular extension 201 such as aligned with the internal support structure 140 of the inner portion 150.

The single spanwise support elements 212 in such embodiments can connect to the inner portion 150 through a variety of suitable connections. For example, in some embodiments, such as when the inner portion 150 comprises a shear web 141, the single spanwise support element 212 may be connected directly or indirectly to the shear web 141 such that their loads are distributed there between. In such embodiments, the single spanwise support element 212 may connect to the shear web 141 via a tapered connection, rabbit fit connection, overlapping connection or any other suitable connection configuration. Moreover, the single spanwise support element 212 may be secured to the shear web 141 via any suitable adhesive, bolts, screws, pins, laminates or the like. In some embodiments the single spanwise support element 212 may be configured to connect to a standardized root stub of the inner portion. The standardized root stub can have a standard connection and profile that facilitates future connections with future spanwise support elements 210 such as those in the modular extensions 201. The standardized root stub may extend past the remainder of the inner portion 150 (such that it will at least partially extends into the modular extension 201), be flush with the edge of the inner portion 150, or even be recessed within the inner portion 150.

The single spanwise support element 212 may further comprise any cross-sectional configuration and length suitable to support the modular extension 201 as should be appreciated herein. For example, in some embodiments, the single spanwise support elements 21 may comprise an “I” shaped cross-section (similar to a traditional shear web and spar cap design or a commercially available I-beam), a cylindrical cross-section, linear cross-section, or any other suitable design.

In some embodiments, the length L of the single spanwise support element 212 may be selected from a group of spanwise support elements having a set amount of predetermined lengths. For example, a group of spanwise support elements may be available having a short, intermediate, or extended length. In some embodiments, such options may correspond to overall blade lengths (e.g., 120 meters, 127 meters, 135 meters, 141 meters, etc.) The single spanwise support element 212 may thus be selected based on the desired final length for the rotor blade 200. In other embodiments, the single spanwise support element 212 may have a length that is customizable such that it can be reduced on-site for that specific rotor blade 200.

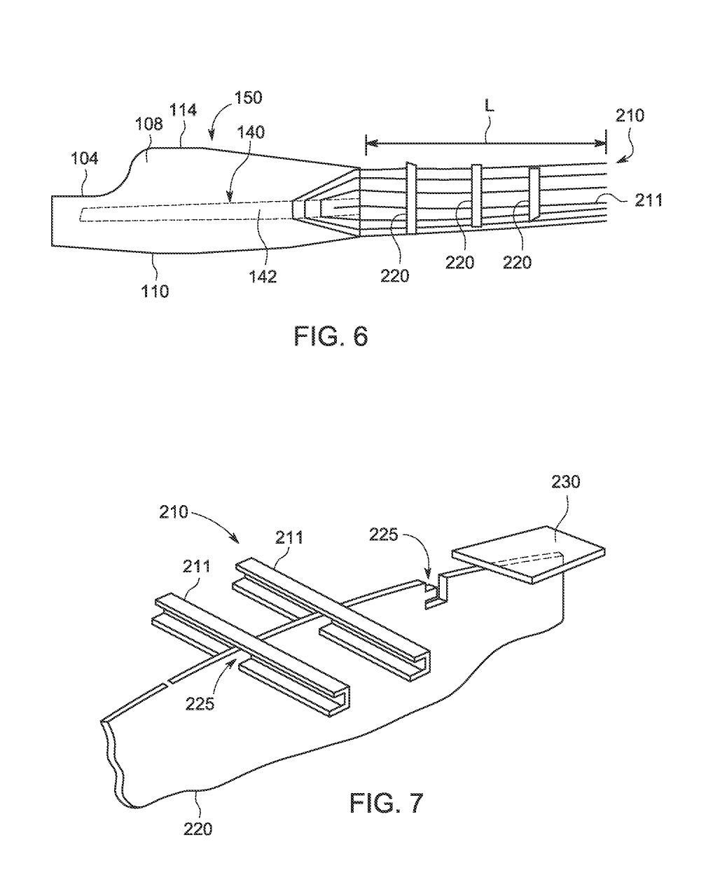

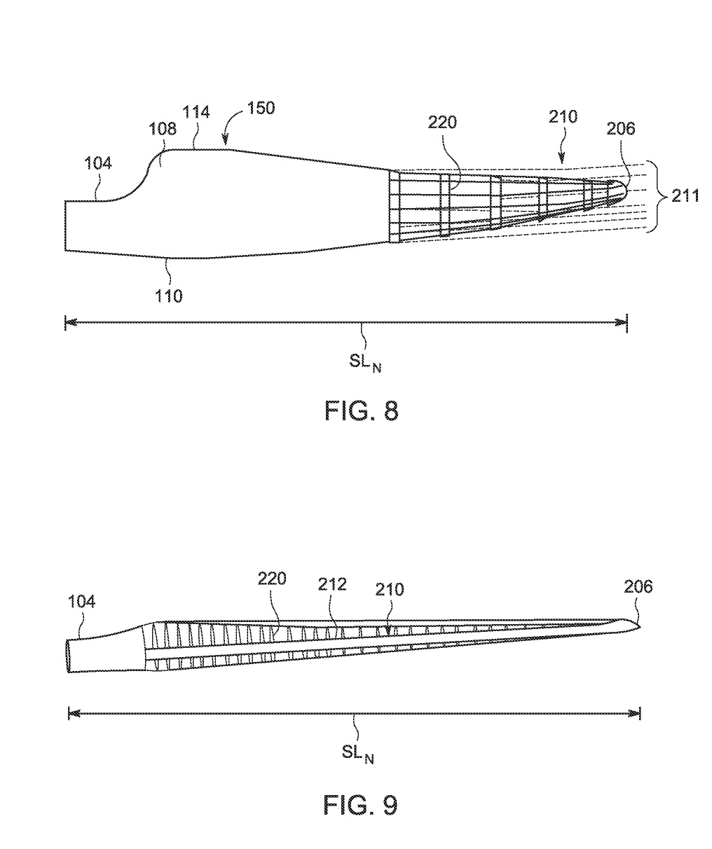

Referring now to FIGS. 6-8, the plurality of cross-sectional ribs 220 comprise a series or support structures (e.g., bulkheads) connected to and disposed along the length L of the one or more spanwise support elements 210. Once installed, the plurality of cross-sectional ribs 220 can support the modular extension shell 230 (as will become appreciated herein) and further potentially define the shape of the modular extension 201 by bending and holding the one or more spanwise support elements 210 in a final position. For example, the plurality of cross-sectional ribs 220 can cause the plurality of spanwise support elements 211 to reposition from a substantially linear profile (e.g., see the dotted lines of the linear profile illustrated in FIG. 8) to an aerodynamic profile (e.g., see the solid lines of the aerodynamic profile illustrated in FIG. 8). This can allow for the utilization of a plurality of standardized, potentially linear, spanwise support elements 211 that are not predisposed in an aerodynamic profile but only form the aerodynamic profile by the connection (e.g., sliding) with the plurality of cross-sectional ribs 220. Such utilization may facilitate more simplified shipping, standardization and/or other efficiencies. The plurality of cross-sectional ribs 220 may be provided in any number, configuration, distribution and material that suitably support the modular extension shell 230 of the rotor blade 200.

In some embodiments, the plurality of cross-sectional ribs 220 may be evenly distributed along the length L of the spanwise support elements 210. In other embodiments, the plurality of cross-sectional ribs 220 may be spaced closer together or farther apart as they approach the new blade tip 206 of the modular extension 201. Furthermore, the plurality of cross-sectional ribs 220 may decrease in cross-sectional size as they approach the new blade tip 206 of the modular extension 201. For example, as illustrated in FIG. 6, the cross-sectional rib 220 farthest from the blade root 104 may be smaller than the cross-sectional rib 220 closest to the blade root 104. Such embodiments can allow for the subsequent tapered shaping of the modular extension shell 230 to promote an aerodynamic profile for the rotor blade 200.

The plurality of cross-sectional ribs 220 may connect to and be installed with the one or more spanwise support elements 210 in a variety of methods. For example, in some embodiments, the one or more spanwise support elements 210 may slide over or through each of the plurality of cross-sectional ribs 220 as illustrated in FIG. 7. In such embodiments, the plurality of cross-sectional ribs may comprise one or more receiving slots 225 that correspond with the cross-sectional shape of the one or more spanwise support elements. The one or more spanwise support elements 210 may therefore slide over or through the receiving slots 225 as each cross-sectional rib 220 is installed. In some embodiments, additional features (e.g., blocks, tabs, brackets, etc.) may further connect the one or more spanwise support elements 210 with the cross-sectional ribs 220. In some embodiments, adhesives, laminates and/or other materials may further connect the one or more spanwise support elements 210 with the cross-sectional ribs 220.

In embodiments comprising a plurality of spanwise support elements 211 (such as illustrated in FIGS. 6-8), the plurality of cross-sectional ribs 220 can reposition (e.g., bend) the plurality of spanwise support elements 211 into position for the rotor blade 200 by selectively positioning receiving slots 225 or other connection features. For example, with specific reference to FIG. 8, the cross-sectional ribs 220 closer to the new blade tip 206 (and/or even the new blade tip 206 itself), can position the plurality of spanwise support elements 210 closer to one another and/or bend them about the span direction to form a suitable overall shape for the rotor blade 200 (i.e., an aerodynamic profile). Such embodiments allow for the plurality of cross-sectional ribs 220 to reposition the plurality of spanwise support elements 211 from a substantially linear profile to an aerodynamic profile as discussed above and illustrated in FIG. 8).

Referring now specifically to FIGS. 6 and 8, in some embodiments (e.g., those including a plurality of spanwise support elements 211), the one or more spanwise support elements 210 can be cut down to size before or after the plurality of cross-sectional ribs are installed such that they do not extend outside of the final profile of the rotor blade 200. For example, if one or more of the spanwise support elements 211 are longer than the new span length SL_{N} of the rotor blade 200, then it may have a suitably sized portion removed before or after the plurality of cross-sectional ribs 220 are connected.

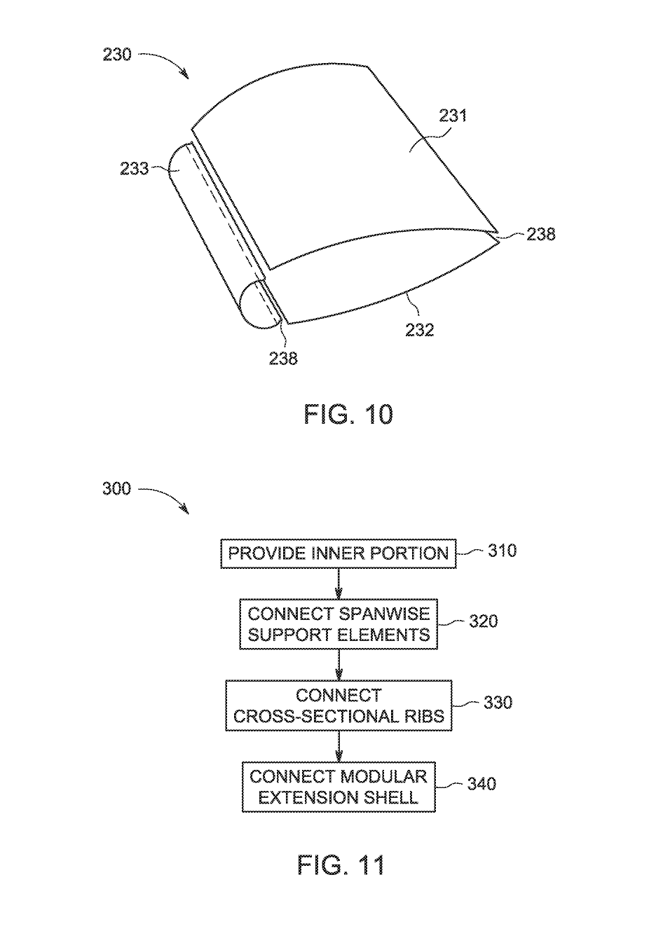

Referring now to FIGS. 7 and 10, the modular extension 201 further comprises a modular extension shell 230. The modular extension shell 230 can surround the modular extension 201 (and thus the plurality of cross-sectional ribs 220) and be supported by the plurality of cross-sectional ribs 220.

In some embodiments, the modular extension shell 230 may comprise a plurality of composite sections 231, 232 and 233 connected at a plurality of seems 238. For example, referring to FIG. 10, the modular extension shell 230 can comprise a first section 231 forming the pressure side, a second section 232 forming the suction side, and a third section 233 forming the leading edge. Each of the composite sections 231, 232 and 233 may be brought together around the plurality of cross-sectional ribs 220 to give the modular extension 201 its aerodynamic profile. In some embodiments, one or more of the plurality of composite sections 231, 232 and 233 may be customizable during installation (similar to the one or more spanwise support elements 210 discussed above) such that the proper fit and dimensions can be achieved using standard sized sections.

In other embodiments, the modular extension shell 230 may comprise a single piece. For example, the modular extension shell 230 may comprise a tensioned fabric wrapped around the plurality of cross-sectional ribs 220. As should be appreciated to those skilled in the art, the tensioned fabric can be wrapped around the outer circumference of the plurality of cross-sectional ribs 220 to define the aerodynamic profile and may comprise any material suitable to capture incoming wind to facilitate the rotation of the rotor blade 200.

The modular extension shell 230 may merge with the shell 108 of the inner portion 150 through any suitable configuration. For example, the two shells may overlap, meet at a seam, taper into one another, or possess any other suitable connection.

As best illustrated in FIGS. 8 and 9, the modular extension 201 may further comprise a new blade tip 206. The new blade tip 206 may be formed via the modular extension shell 230, one of the plurality of cross-sectional ribs 220 and/or a separate element. For example, in some embodiments, the last of the cross-sectional ribs may be configured to form the new blade tip 206. In other embodiments, a standardized blade tip (such as one using the same standardized connection as a standardized root stub discussed above) may be utilized. The new blade tip 206 may be connected to the modular extension 201 in any manufacturing order and may comprise any material or materials suitable for the end of a wind turbine rotor blade.

The modular extension 201 thereby combines with the inner portion 150 to form the rotor blade 200. The rotor blade 200 has a new span length SL_{N} (FIGS. 8 and 9). If the rotor blade 200 was manufactured utilizing an inner portion 150 from an original rotor blade 100 (as opposed to an inner portion 150 of a new make part) the new span length SL_{N} can be different than the original span length SL_{O} of the original rotor blade 100 (FIG. 2). For example, the new span length SL_{N} can be greater than or less than the original span length SLₒ based on the modification used for that particular rotor blade. Moreover, in some embodiments the modular extension 201 may comprise at least 50% percent of the new span length SL_{N}. For example, the modular extension 201 may comprise at least about 50%, at least about 75% or even at least about 90% of the SL_{N}.

Referring now also to FIG. 11, a method 300 for modifying a rotor blade is illustrated. The method first comprises providing an inner portion 150 (e.g., such as from of an original rotor blade 100 by removing an outer portion 160) in step 310. As discussed above, this can be achieved by the use of new make, or by the use of an original rotor blade 100 and saws, blades, torches, lasers or any other suitable device and can be done in the field, at a maintenance/repair facility or at the place of original manufacturing. The method 300 further comprises connecting one or more spanwise support elements 210 to the inner portion 150 in step 320. As discussed above, the one or more spanwise support elements 210 can extend in the spanwise direction and can comprise any number, shape, material and configuration suitable for the modular extension 201. In some embodiments, the method 300 can further comprise customizing (e.g., cutting, shortening, etc.) at least one of the one or more spanwise support elements 210 to a custom length. Such embodiments may exist, for example, when the one or more spanwise support elements were provided in a standard length. Furthermore, such customization may occur at any point during the method 300.

The method 300 further comprises connecting a plurality of cross-sectional ribs 220 to the one or more spanwise support elements 210 in step 330. As also discussed above, the plurality of cross-sectional ribs 220 can be disposed about the length of the one or more spanwise support elements such that they can subsequently define the aerodynamic profile of the modular extension 201. It should be appreciated that connecting the cross-sectional ribs in step 330 and connecting the spanwise support elements in step 320 can occur in any relative order.

Finally, the method 300 can further comprise connecting the modular extension shell 230 in step 340. As discussed above, the modular extension shell can surround and be supported by the plurality of cross-sectional ribs 220 such that it forms the aerodynamic profile of the modular extension. The modular extension shell 230 may comprise any number of components, any material or materials, and any connection mechanisms suitable for a wind turbine rotor blade.

It should now be appreciated that rotor blades may be modified with modular extensions to produce rotor blades of different lengths. When modifying preexisting rotor blades, the new, modified rotor blades can have different span lengths than the original rotor blades to allow for more readily available customization. For example, using modular or standardized components, the modular extensions can be retrofitted onto the inner portions of original rotor blades. This can provide more conducive customization for increased efficiency based on the operational requirements for each individual rotor blade.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A rotor blade for a wind turbine, the rotor blade comprising:
an inner portion; and,
a modular extension attached to the inner portion to form a span length for the rotor blade, the modular extension comprising:
one or more spanwise support elements connecting to the inner portion and extending in a spanwise direction;
a plurality of cross-sectional ribs disposed along a length of the one or more spanwise support elements; and,
a modular extension shell surrounding the modular extension supported by the plurality of cross-sectional ribs.

2. The rotor blade of claim 1, wherein the one or more spanwise support elements comprise a plurality of spanwise support elements.

3. The rotor blade of claim 2, wherein the plurality of cross-sectional ribs cause the plurality of spanwise support elements to reposition from a substantially linear profile to an aerodynamic profile.

4. The rotor blade of claim 2, wherein the plurality of spanwise support elements connect to an internal support structure of the inner portion.

5. The rotor blade of claim 2, wherein the length of the plurality of spanwise support elements is customized for the rotor blade.

6. The rotor blade of claim 2, wherein the plurality of spanwise support elements are distributed around at least a portion of an outer circumference of the modular extension.

7. The rotor blade of claim 1, wherein the plurality of cross-sectional ribs comprise receiving slots shaped to receive a cross-section of the one or more spanwise support elements.

8. The rotor blade of claim 1, wherein the one or more spanwise support elements is a single spanwise support element.

9. The rotor blade of claim 8, wherein the single spanwise support element connects to a standardized root stub of the inner portion.

10. The rotor blade of claim 8, wherein the single spanwise support element is selected from a group of predetermined lengths.

11. The rotor blade of claim 1, wherein the modular extension shell comprises a tensioned fabric.

12. The rotor blade of claim 1, wherein the modular extension comprises at least 50% of the span length.

13. A method for modifying a rotor blade, the method comprising:
providing an inner portion of a rotor blade by removing an outer portion;
connecting one or more spanwise support elements to the inner portion such that the one or more spanwise support elements extend in a spanwise direction;
connecting a plurality of cross-sectional ribs to the one or more spanwise support elements, the plurality of cross-sectional ribs disposed along a length of the one or more spanwise support elements; and,
connecting a modular extension shell that surrounds and is supported by the plurality of cross-sectional ribs.

14. The method of claim 13, wherein connecting the plurality of cross-sectional ribs to the one or more spanwise support elements causes the plurality of spanwise support elements to reposition from a substantially linear profile to an aerodynamic profile.

15. The method of claim 13, wherein the one or more spanwise support elements are provided in a standard length, the method further comprising customizing at least one of the one or more spanwise support elements to a custom length from the standard length based on the rotor blade.

16. The method of claim 13 further comprising selecting the one or more spanwise support elements from a group of spanwise support elements having a set amount of predetermined lengths.

17. The method of claim 13, wherein connecting the one or more spanwise support elements to the inner portion comprises connecting a single spanwise support element to a standardized root stub of the inner portion.

18. The method of claim 13, wherein providing the inner portion of the rotor blade comprises removing an outer portion from the inner portion of an original rotor blade.

19. The method of claim 13, wherein connecting the modular extension shell comprises wrapping the plurality of cross-sectional ribs with tensioned fabric such that the plurality of cross-sectional ribs support the tensioned fabric into an aerodynamic profile.

20. The method of claim 13, wherein the plurality of cross-sectional ribs are connected to the one or more spanwise support elements after the one or more spanwise support elements are connected to the inner portion.
